(19) United States
(12) Patent Application Publication
(10) Pub. No.: US 2013/0008748 A1
(43) Pub. Date: Jan. 10, 2013

(54) FRICTION DISK HAVING AN ANTI-WEAR LAYER AND INTEGRATED WEAR INDICATION AND COMPOSITIONS OF THE ANTI-WEAR LAYER

(75) Inventors: Oliver Lembach, Sindelfingen (DE); Ralph Mayer, Boeblingen (DE)

(73) Assignee: DAIMLER AG, Stuttgart (DE)

(21) Appl. No.: 13/634,630

(22) PCT Filed: Mar. 16, 2011
(86) PCT No.: PCT/EP2011/001277

§ 371 Date: Sep. 13, 2012

(30) Foreign Application Priority Data
Mar. 30, 2010 (DE) 10 2010 013 343.4

(51) Int. Cl. F16D 66/02; C22C 27/04; C22C 38/40; C04B 35/00; C04B 35/56; C01B 31/30; C01B 31/36; C01G 23/047; C01F 7/02; C04B 35/01; C04B 35/10; F16D 65/12; C01B 31/34

(52) U.S. Cl. 188/1.11 W; 420/430; 420/43; 501/94; 501/87; 501/93; 423/440; 423/345; 423/610; 423/625; 501/127; 501/88

(57) ABSTRACT

A friction disc (2) with an anti-abrasion layer (1) and integrated wear indication, the friction disc (2) having a friction surface (2′) which is completely covered by the anti-abrasion layer (1). At least one indication surface element (3) which occupies a part of the friction surface (2′) and differs from at least one of the components friction surface (2′) and anti-abrasion layer (1) of the friction disc (2) in at least one of the features coloring and texture is provided between the anti-abrasion layer (1) and the friction disc (2). Compositions of the anti-abrasion layer (1) of the friction disc (2).

The invention relates to a friction disc, in particular a brake disc for disc brakes, with an anti-abrasion layer and integrated wear indication. The invention further relates to compositions of the anti-abrasion layer of the friction disc.

It is known that friction systems are expediently equipped with a device by means of which it can be detected when the service life of a friction disc is exceeded owing to wear and the disc should be replaced. In this context, DE 101 18 920 C1 describes a friction disc made of a ceramic composite material reinforced with carbon fibres, wherein a part of the friction surface consists of another, in particular carbon-containing, material having a lower wear and oxidation resistance than the rest of the friction surface. The higher wear caused thereby in operation changes the balance of the friction disc and generates a visual, audible or mechanical signal when the friction disc exceeds its service life.

From EP 0 411 284 A2, a wear indicator for indicating the wear limits of brake pads on motor vehicle is known, which is claimed to have a simple structure and to be capable of low-cost production while functioning reliably. For this purpose, a U-shaped conductor loop is placed in a plug which is installed into a bore of the brake shoe backing plate. When the wear limit is reached and the conductor loop contacts the brake disc, an electric signal is triggered.

To enable a brake disc to be checked visually in order to establish its remaining service life and to detect irregular wear, U.S. Pat. No. 4,457,566 B1 discloses a brake disc with a visual wear indicator. For this purpose, the brake disc has in the surface of at least one friction surface a recess extending substantially parallel thereto, this recess being so deep that the brake disc below still retains a minimum thickness.

On the basis of this prior art, it is desirable to provide a friction, disc, in particular a brake disc, which is provided on the one hand with an anti-abrasion layer to reduce brake dust formation in order to minimise the emission of fine dust into the environment and on the other hand with a wear indicator by means of which it can be visually detected in a simple way when the coefficient of friction if the friction disc equipped with the anti-abrasion layer changes and the friction disc has to be replaced to avoid increased wear and dust emission.

This problem is solved by a friction disc with the features of claim 1.

Further developments of the subject matter are specified in the dependent claims.

It is further desirable to provide a composition of the anti-abrasion layer which is suitable for application to the friction surface of a brake disc of any material and any design in order to reduce fine dust emission.

This problem is solved by compositions with the features of claim 7.

A first embodiment of the invention relates to a friction disc which is used as a brake disc for disc brakes or as a clutch disc and which is provided with an anti-abrasion layer on the friction surface of the friction disc in order to minimise wear and therefore fine dust formation. As the interaction between friction lining and friction disc forms a special friction system, an indication of the service life of the anti-abrasion layer or an indication that the service life of the layer on the friction surface has been exceeded is highly important. Between the anti-abrasion layer, which fully covers the friction surface, and the friction disc, one or more indication surface elements are provided, which occupy a part of the friction surface and differ markedly from the friction surface and/or from the anti-abrasion layer in their colouring and/or texture. If more than one indication surface element is provided, these elements can be distributed across the friction surface at a distance from one another; however, the design of an indication surface element as a continuous annular structure is also conceivable.

By means of the indication surface elements provided between the anti-abrasion layer and the friction surface of the friction disc, it can be detected when the wear state of the anti-abrasion layer has become critical and the friction disc has to be replaced. If the anti-abrasion layer is worn, the coefficient of friction changes, affecting the interaction between the friction lining and the friction disc, resulting in increased wear of the friction disc and increased fine dust formation.

The indication surface element located below the anti-abrasion layer is exposed as soon as the anti-abrasion layer is worn away to the specified depth, because the indication surface element can in these conditions project into the anti-abrasion layer.

The indication of critical wear is in particular provided by visually detectable indication surface elements. In one embodiment of the invention, these may simply be represented by an indentation in the friction surface of the friction disc, the contour of which indentation is noticeable if the anti-abrasion layer is worn away. In a further variant, the indentation can be filled with an indication material having a colour and/or texture which differs from the surrounding friction surface.

As an alternative, but particularly in addition to the visual indication, the indication surface element can be provided with a haptic action. For this purpose, very rough or porous indication materials, for example, are suitable, because the difference between their texture and that of the smooth brake disc surface can be felt easily.

In a further embodiment of the invention, a layer of the indicator material serving as an indication surface element is placed not in, but on the friction surface and then surrounded by the anti-abrasion layer, differing from the anti-abrasion layer at least in colour or texture.

The anti-abrasion layer is applied to the friction surface of the friction disc to a thickness of 10 to 200 μm, preferably 10 to 50 μm; it is therefore very thin and primarily intended for use on a friction disc on a metallic material.

The friction disc provided with the anti-abrasion layer can be made of grey cast iron, steel or an aluminum alloy. The indication surface element lies under the anti-abrasion layer and becomes visible only when a critical state of wear has been reached. For this purpose, it is for example made of a coloured, black or white ceramic material, a mineral pigment and/or a woven or braided fabric. Metal or ceramic foams are also suitable. The anti-abrasion layer itself is made either of a ceramic material, in particular based on carbides or oxide ceramics, of a cermet which is preferably a composite of a carbide or oxide ceramic material in a metallic matrix, or it may be made of a hard metal alloy.

Mechanically resistant ceramic material particles which in particular consist of aluminum oxide (corundum) or titanium dioxide can also be embedded in the anti-abrasion layer.

Further embodiments of the invention relate to compositions of the anti-abrasion layer of a friction disc according to the invention, depending on whether a metal alloy, a cermet or a ceramic material is involved.

If the anti-abrasion layer is made of a metal alloy, the composition may for example consist of a chromium- or nickel-containing tungsten base alloy and/or a chromium/nickel steel. The tungsten base alloy is a composition which preferably comprises 20 to 35% by weight of chromium and 5 to 15% by weight of nickel, in particular 27% by weight of chromium and 10% by weight of nickel, made up to 100% by weight by a residual tungsten component and traces of impurities common in alloys. The alternative chromium/nickel steel contains in a preferred embodiment at least 16% by weight of chromium and at least 10% by weight of nickel; a chromium content of 16.5 to 20% by weight and a nickel content of 10 to 26% by weight are particularly preferred.

If a cermet is used for the anti-abrasion layer, this may be composed of a tungsten alloy containing ceramic particles of Al₂O₃, TiO₂ and/or SiC. An alternative cermet is represented by WC and/or CrC in a metallic matrix of Ni, Co and/or Cr, 60 to 85% by weight of WC being preferred. Particularly suitable is a cermet containing 70 to 85% by weight of WC and 7 to 12% by weight of Co.

A further embodiment of a composition according to the invention for an anti-abrasion layer of a friction disc relates to a ceramic material consisting of WC, CrC, SiC, Al₂O₃, TiO₂ or a combination thereof. Preferred ceramic materials are composed of WC and Al₂O₃ or of Al₂O₃ and TiO₂, the latter preferably containing 60 to 97% by weight of Al₂O₃ and 3 to 40% by weight of TiO₂.

The above advantages as well as further advantages are explained in the description below with reference to the accompanying figures.

References to the figures in the description are intended to support the description and to promote the understanding of the subject matter. Objects or parts of objects which are substantially identical or similar may be identified by the same reference numbers. The figures only provide a diagrammatic representation of an embodiment of the invention.

Of the figures:

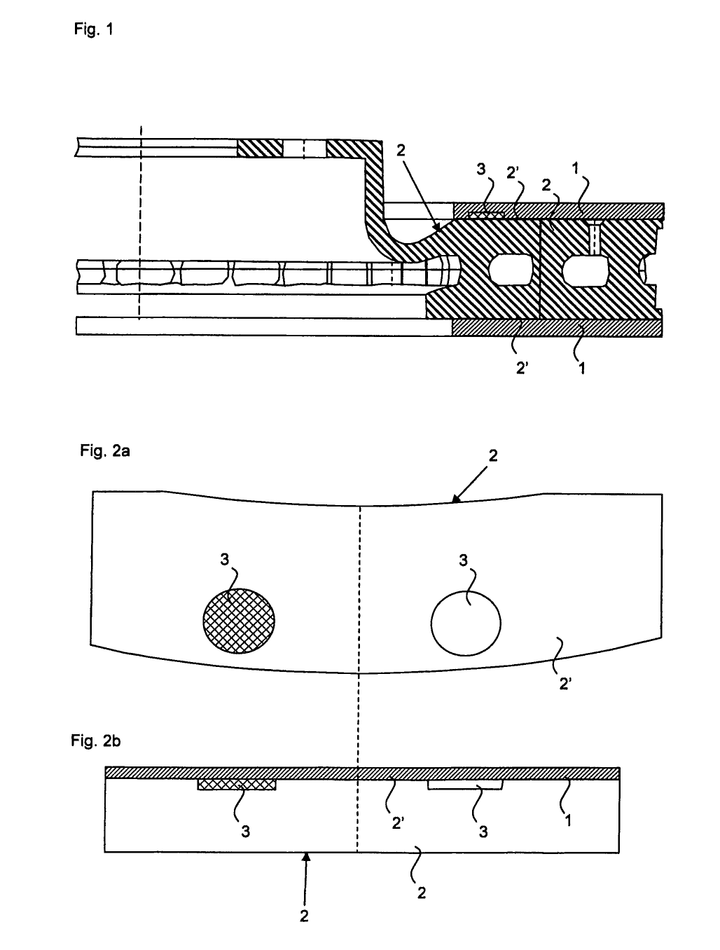

FIG. 1 shows part of a lateral cross-section of a brake disc provided with an anti-abrasion layer and wear indication;

FIG. 2a is a top view of a friction surface section with two different wear indicators; and

FIG. 2b is a lateral sectional view corresponding to the view from FIG. 2a.

The friction disc according to the invention is primarily intended for brake discs, but other friction discs, such as clutch discs, are included. The brake disc may be a composite brake disc or a brake disc made of solid material, in either case being provided according to the invention with an anti-abrasion layer on the friction surface of the friction ring of the friction disc and with an integrated wear indication.

FIG. 1 shows a ventilated brake disc 2 which may be produced from grey cast iron, steel or an aluminum alloy. On each of the two friction surfaces 2′ of the friction disc 2, which face away from each other, an anti-abrasion layer 1 with a thickness of less than 200 μm, preferably less than 50 μm, is applied. As an indication surface element 3, FIG. 1 shows a locally applied layer of an indicator material which is surrounded by the ant-abrasion layer 1. This indication surface element 3 becomes visually detectable when the ant-abrasion layer 1 is abraded or worn. Conceivably at least one further indication surface element 3, which is not shown in the drawing, could be provided on the second friction surface; this would, however, not be directly visible from the outside when the brake disc is mounted on a vehicle.

FIGS. 2a and 2b show two different embodiments of an indication surface element 3, in both cases represented initially by an indentation 3 in the friction surface 2′ of the friction disc 2. While the indication surface element 3 shown on the right-hand side is merely represented by a counterbore, so that, when the anti-abrasion layer 1 is worn away, only its contour, e.g. a blind hole, becomes visible as shown in FIG. 2a, the indentation on the left-hand side is filled with an indication material 3 which differs from the friction surface 2′ in its colour and/or texture. Differences in colour can be obtained by using white, black or coloured materials as an indicator material, but there may also be discolouration by chemical, in particular oxidative, reaction due to the heat of the friction system.

Suitable indicator materials generally are, for example, ceramic materials which may have a white colouring from Al₂ O₃ or TiO₂ or a black colouring from SiC. Further colours can be obtained by using mineral colours such as metal oxides. The ceramic material can be installed into an indentation as an inlay or applied to the friction surface before the application of the anti-abrasion layer. It can be secured using a suitable bonding process or by welding or soldering. The indicator element is preferably incorporated in the casting process of the friction disc.

In a preferred embodiment in which the anti-abrasion layer consists of a metal/ceramic composite material, a white ceramic material can be used as an indicator material; this is first injected into the indicator recess in the production process, for example while the coating is being applied, followed by the application of the anti-abrasion layer by switching the spraying device to metal/ceramic coating.

Different textures for the visual detection of the indication surface element can be obtained by means of a cast-in part made of metal fibres, metal fabric or metal plaiting, for example by casting a small steel mesh part into an aluminum brake disc. In this way, metal or ceramic foams can also be implemented to advantage. When the anti-abrasion layer has exceeded its service life and is abraded or worn, the fabric or the foam respectively is exposed, so that the fibres or foams which differ from the friction surface in their colour and/or texture become visually or even haptically detectable.

Together with a friction lining, e.g. a brake pad, the compositions for the anti-abrasion layer of friction discs according to the invention form a special friction system characterised by low wear and fine dust formation. By means of the integrated wear indicator, it is possible to detect precisely when the friction disc has to be changed in order to avoid a change in the coefficient of friction accompanied by increased wear and brake dust formation.

The indication surface element can be represented by one or more local surface elements. FIG. 2 shows a circular element, but the shape can of course deviate from that shown in the figure. Any geometrical figures and design elements are conceivable; indication surface elements may be triangular, star-shaped or have the form of letters. If the indication surface element is a continuous annular structure, this may be a circular ring or a curved or scalloped band. The continuous structure is particularly easy to recognise, because, in contrast to locally applied elements, it cannot be hidden by the rim mounted in front of the brake disc. If a continuous indication surface element is provided, the first glance can detect whether the brake disc has to be replaced or not, even if the wheels are in place.

A preferred composition of an anti-abrasion layer consists of WC and Al₂O₃ or of Al₂O₃ and TiO₂ as ceramic materials. The latter preferably contains 60 to 97% by weight of Al₂O₃ and 3 to 40% by weight of TiO₂. Alternatively, a composition for an anti-abrasion layer can be based on W, which may be a tungsten base alloy with Cr and/or Ni containing preferably 20 to 35% by weight of Cr and 5 to 15% by weight of Ni as well as W and any impurities common in alloys. A preferred tungsten base alloy contains 27% by weight of Cr and 10% by weight of Ni. Mechanically resistant ceramic particles, in particular of Al₂O₃ and/or TiO₂, can be integrated into such a tungsten base alloy.

If Cr/Ni steel is used for the anti-abrasion layer, it may contain at least 16% by weight of Cr and at least 10% by weight of Ni. An anti-abrasion layer represented by a ceramic injection-moulded layer of Cr/Ni steel may preferably have a Cr content of 16.5 to 20% by weight and an Ni content of 10 to 20% by weight.

Cermets of carbide (oxide) ceramics in a metallic matrix may be made of W and/or CrC in a metallic matrix of N, Co, and/or Cr for use as an anti-abrasion layer. A tungsten carbide component would in this case amount to 60 to 85% by weight, and a preferred composition consists of 70 to 85% by weight of WC and 7 to 12% by weight of Co. Another conceivable composition for an anti-abrasion layer would consist of Al₂O₃, TiO₂ and/or SiC in a tungsten matrix.

1. A friction disc (2) with an anti-abrasion layer (1) and integrated wear indication, the friction disc (2) having a friction surface (2′) and the anti-abrasion layer (1) completely covering the friction surface (2′), wherein at least one indication surface element (3) which occupies a part of the friction surface (2′) and differs from at least one of the components friction surface (2′) and anti-abrasion layer (1) of the friction disc (2) in at least one of the features coloring and texture is provided between the anti-abrasion layer (1) and the friction disc (2).

2. The friction disc (2) according to claim 1, wherein several indication surface elements (3) are distributed across the friction surface at a distance from one another.

3. The friction disc (2) according to claim 1, wherein the indication surface element (3) is an indentation in the friction surface (2′) of the friction disc (2), or is represented by a layer of an indicator material which is placed in an indentation or on the friction surface (2′).

4. The friction disc (2) according to claim 1, wherein the anti-abrasion layer (1) has a thickness of 10 to 200 μm.

5. The friction disc according to claim 3, wherein
the indicator material is a colored, black or white ceramic material, a mineral pigment and/or a woven or braided fabric,
the anti-abrasion layer (1) consists of a ceramic material, of a cermet or of a metal alloy, and
the friction disc (2) consists of grey cast iron, a steel or an aluminum alloy.

6. The friction disc (2) according to claim 5, wherein mechanically resistant particles of a ceramic material are embedded into the anti-abrasion layer (1).

7. The composition of an anti-abrasion layer (1) of a friction disc (2) according to claim 1, wherein the anti-abrasion layer consists of a metal alloy, a cermet or a ceramic material.

8. The composition according to claim 7, wherein
the metal alloy
comprises a Cr- and/or Ni-containing tungsten base alloy, made up to 100% by weight by a residual W component and traces of impurities common in alloys, or
consists of a Cr/Ni steel.

9. The composition according to claim 7, wherein
the cermet
comprises a tungsten alloy with one or more of Al₂O₃, TiO₂, SiC or
consists of WC and/or CrC in a metallic matrix of Ni, Co and/or Cr.

10. The composition according to claim 7, wherein
the ceramic material consists of WC, CrC, SiC, Al₂O₃ or TiO₂ or a combination thereof.

11. The friction disc (2) according to claim 1, wherein the indication surface element (3) is designed as a continuous annular structure.

12. The friction disc (2) according to claim 1, wherein the anti-abrasion layer (1) has a thickness of 10 to 50 μm.

13. The friction disc according to claim 5, wherein the ceramic material is a carbide or oxide ceramic material, and the cermet is a carbide or oxide ceramic material in a metallic matrix.

14. The friction disc (2) according to claim 6, wherein the mechanically resistant particles of a ceramic material are at least one of Al₂O₃ or TiO₂.

15. The composition according to claim 8, wherein the Cr- and/or Ni-containing tungsten base alloy is a tungsten base alloy containing 20 to 35% by weight of Cr and 5 to 15% by weight of Ni, and wherein the Cr/Ni steel is a Cr/Ni steel containing at least 16% by weight of Cr and at least 10% by weight of Ni.

16. The composition according to claim 15, wherein the Cr- and/or Ni-containing tungsten base alloy contains 27% by weight of Cr and 10% by weight of Ni, and wherein the Cr/Ni steel is a Cr/Ni steel containing 16.5 to 20% by weight of Cr and 10 to 26% by weight of Ni.

17. The composition according to claim 9, wherein the cermet contains 60 to 85% by weight of WC and 7 to 12% by weight of Co.

18. The composition according to claim 17, wherein the cermet 70 to 85% by weight of WC.

19. The composition according to claim 7, wherein the ceramic material consists of a combination of WC and Al₂O₃ or Al₂O₃ and TiO₂.

20. The composition according to claim 19, wherein the ceramic material consists of a combination of Al₂O₃ and TiO₂ in a composition of 60 to 97% by weight of Al₂O₃ and 3 to 40% by weight of TiO₂.
